(19) United States
(12) Patent Application Publication
(10) Pub. No.: US 2013/0185482 A1
(43) Pub. Date: Jul. 18, 2013

(54) MEMORY SYSTEM USING A STORAGE HAVING FIRMWARE WITH A PLURALITY OF FEATURES

(71) Applicants: Dae-Ho KIM, Hwaseong-si (KR); Seong-Nam KWON, Bucheon-si (KR); Myung-Hyun JO, Hwaseong-si (KR)

(72) Inventors: Dae-Ho KIM, Hwaseong-si (KR); Seong-Nam KWON, Bucheon-si (KR); Myung-Hyun JO, Hwaseong-si (KR)

(73) Assignee: SAMSUNG ELECTRONICS CO., LTD., Suwon-si, (KR)

(21) Appl. No.: 13/733,309

(22) Filed: Jan. 3, 2013

(30) Foreign Application Priority Data
Jan. 18, 2012 (KR) 10-2012-0005764

(51) Int. Cl. G06F 12/02

(52) U.S. Cl. CPC G06F 12/0246
USPC 711/103

(57) ABSTRACT

A memory system includes a host including a configuration controller to receive an input command and to output a configuration command corresponding to the input command, and a storage to be driven by firmware including a plurality of features, the storage including an adaptation controller to receive the configuration command from the configuration controller and to determine whether to enable each of the features.

### CROSS-REFERENCE TO RELATED APPLICATIONS

This application claims priority under 35 U.S.C. §119 from Korean Patent Application No. 10-2012-0005764 filed on Jan. 18, 2012 in the Korean Intellectual Property Office, and all the benefits accruing therefrom under 35 U.S.C. 119, the contents of which in its entirety are herein incorporated by reference.

### BACKGROUND

1. Field

The present inventive concept relates to a memory system using a storage having firmware with a plurality of features to be selected according to a use environment.

2. Description of the Related Art

A hard disk drive has been most commonly known and used as a large-capacity media storage device. However, with a decrease of the price of a NAND flash memory semiconductor device configured such that internally stored data is not erased even without the supply of power, to solid state drive (SSD) has emerged as a large-capacity digital media storage device using a semiconductor device having a memory function.

The solid state drive has write and read speeds 3 to 5 times faster than those of the conventional hard disk. Also, the read/write speed of the solid state drive required in a database management system or the like to read and write data at any address is hundreds of times faster than that of the conventional hard disk. In addition, since the solid state drive operates without any noise, it is possible to overcome a noise problem of the conventional hard disk. Further, since the solid state drive has an advantage of operating at a lower power level than that of the hard disk, the solid state drive is known to be most suitable for digital devices such as a laptop requiring low power consumption.

It may be necessary to install a specific firmware in the solid state drive, and the solid state drive is driven through the firmware. However, with an increase of distribution and usages of the solid state drives, the solid state drives can be usable in various environments. Accordingly, it may also be necessary to control operating characteristics of the solid state drive according to the use environment. That is, there is a need f to control the operating characteristics of the solid state drive such that the solid state drive can be optimized for the use environment.

### SUMMARY OF THE INVENTION

The present invention provides a memory system capable of changing operating characteristics of a storage device according a use environment.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a memory system including a host having a configuration controller to receive an input command and to output a configuration command corresponding to the input command, and a storage to be driven by firmware including a plurality of features, the storage having an adaptation controller to receive the configuration command from the configuration controller and to determine whether to enable each of the features.

The foregoing and/or other features and utilities of the present general inventive concept may also be achieved by providing a memory system having a host including a configuration controller to receive an input command and to output first and second configuration commands corresponding to the input command, and a first storage to be driven by a first firmware including a plurality of features, the first storage including a first adaptation controller to receive the first configuration command from the configuration controller and to determine whether to enable each of the features, and a second storage to be driven by a second firmware including a plurality of features, the second storage including a second adaptation controller to receive the second configuration command from the configuration controller and to determine whether to enable each of the features, wherein an enabled feature of the first storage is different from an enabled feature of the second storage.

The foregoing and/or other features and utilities of the present general inventive concept may also be achieved by providing a storage usable with a memory system having a host, the storage including a firmware including a plurality of features and an adaptation controller to receive a configuration command and to determine whether to enable each of the features according to the received configuration command.

The configuration command may be associated with a characteristic of contents stored in the storage or to be stored in the storage.

The configuration command may be associated with a state of the storage

The firmware may include a plurality of modules, one of the modules may include the plurality of features, and the adaptation controller may enable one of the plurality of features according to the configuration command.

The other one of the plurality of modules may include a plurality of second features, and one of the second features is enabled according to a state of the storage during an operation of the storage.

The adaptation controller may determine whether to enable one of the features of the firmware according to a state of the storage. The state of the storage may include a use environment of the storage.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a block diagram illustrating a memory system according to an embodiment of the present general inventive concept;

FIG. 2 illustrates an user interface of a configuration controller of a memory system according to an embodiment of the present general inventive concept;

FIGS. 3 to 7 are diagrams illustrating a method of a memory system according to an embodiment of the present general inventive concept;

FIG. 8 is a block diagram illustrating a memory system according to an embodiment of the present general inventive concept;

FIG. 9 is a block diagram illustrating a memory system according to an embodiment of the present general inventive concept;

FIG. 10 is a block diagram illustrating an application example of the memory system of FIG. 9; and

FIG. 11 is a block diagram illustrating a computing system including the memory system of FIG. 10.

### DETAILED DESCRIPTION OF EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

Advantages and features of the present invention and methods of accomplishing the same may be understood more readily by reference to the following detailed description of embodiments and the accompanying drawings. The present general inventive concept may, however, be embodied in many different forms and should not be construed as being limited to the embodiments set forth herein. Rather, these embodiments are provided so that this disclosure will be thorough and complete and will fully convey the concept of the general inventive concept to those skilled in the art, and the present general inventive concept will only be defined by the appended claims. In the drawings, the thickness of layers and regions are exaggerated for clarity.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

The term “unit” or “module”, as used herein, means, but is not limited to, a software or hardware component, such as a field programmable gate array (FPGA) or an application specific integrated circuit (ASIC), which performs certain tasks. A unit or module may advantageously be configured to reside in the addressable storage medium and configured to execute on one or more processors. Thus, a unit or module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units or modules may be combined into fewer components and units or modules or further separated into additional components and units or modules.

Unless defined otherwise, all technical and scientific terms used herein have the same meaning as commonly understood by one of ordinary skill in the art to which this invention belongs. It is noted that the use of any and all examples, or exemplary terms provided herein is intended merely to better illuminate the invention and is not a limitation on the scope of the invention unless otherwise specified. Further, unless defined otherwise, all terms defined in generally used dictionaries may not be overly interpreted.

Hereinafter, a memory system will be described according to an embodiment of the present general inventive concept.

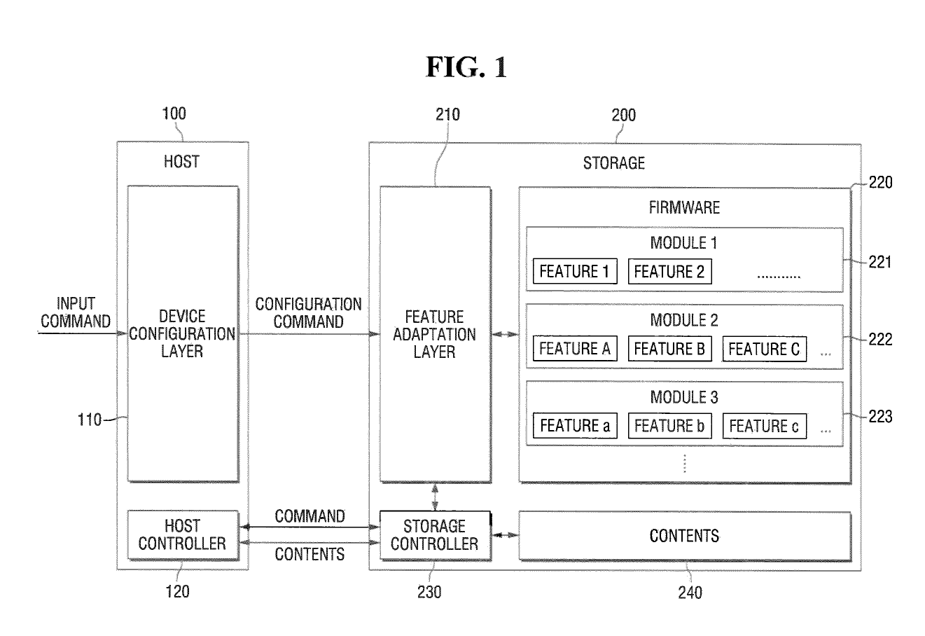

FIG. 1 is a block diagram illustrating a memory system according to an embodiment of the present general inventive concept.

Referring to FIG. 1, the memory system may include a host 100 and a storage 200.

The host 100 may include, as illustrated in FIG. 1, a configuration controller (or device configuration layer) 110 and a host controller 120.

The configuration controller 110 may receive an input command and output a configuration command corresponding thereto. Here, the input command may be a command for controlling the operating characteristics of the storage 200 according to the use environment. The input command may be provided from an outside thereof. For example, the input command may be inputted from a user through a user interface (UI) or the like included in the configuration controller 110. The user interface may be an input unit connected to the configuration controller 110 such that the user can input the input command. The user interface may be a screen of a display unit, for example, a touch panel, such that the user interface is generated from the configuration controller 110 and is displayed on a display unit connected to the host 100 such that the user can input the user command through the touch panel of the display unit.

The host controller 120 may output a command associated with a content read/write operation to a storage controller 230 to allow the host 100 to process contents stored in the storage 200 or store new contents in the storage 200. Here, the processing the contents in the host 100 may be referred to as displaying or printing the contents in the form of image and document, playing back the contents in the form of audio and/or video, and installing or executing the contents in the form of application such as computer program. Here, the host may have a functional unit (not illustrated) to perform the processing operation of the host 100. It is possible that the functional unit may have a mechanical structure and/or an electrical circuit element to perform the processing operation as described above.

The storage controller 230 receives the command associated with the contents from the host controller 120 and controls contents 240 stored in the storage 200 according to the received command. For example, when the received command is a read command, the storage controller 230 may provide the contents 240 stored in the storage 200 to the host 100, and when the received command is a write command, the storage controller 230 may receive new contents from the host 100 and store the received contents in the storage 200.

Although FIG. 1 illustrates the configuration controller 110 and the host controller 120 as separate units, the present general inventive concept is not limited thereto. For example, the configuration controller 110 and the host controller 120 may be implemented as one integrated unit in the host 100 if necessary.

The storage 200 may include an adaptation controller (or feature adaption layer) 210 and the storage controller 230. The storage 200 may store firmware 220 and the contents 240. Here, the firmware 220 may be installed in the storage 200 to drive the storage 200. The contents 240 may be stored in a separate memory area (not illustrated) included in the storage 200.

Referring to FIG. 1, the firmware 220 may include a plurality of modules 221, 222 and 223. Each of the modules 221, 222 and 223 may perform each function associated with the corresponding operation of the storage 200. For example, a first module 221 may be a module associated with a read/write operation of the storage 200, a second module 222 may be a module associated with an operating frequency of the storage 200, and a third module 223 may be a module associated with a garbage collection of the storage 200. In addition, the storage 200 may further include a plurality of modules associated with operational functions of the storage 200.

Meanwhile, each of the modules 221, 222 and 223 may include a plurality of features. Here, one feature may be a group of small units constituting the firmware 220, and various features may be combined to implement one functional unit module 221, 222 or 223.

For example, when the first module 221 is a module associated with the read/write operation of the storage 200, the first module 221 may include a first feature (FEATURE 1) to preferentially process a read command over a write command among the commands received from the host 100, and a second feature (FEATURE 2) to preferentially process a write command over a read command among the commands received from the host 100.

The read command may have a higher priority than that of the write command in the first feature (FEATURE 1) such that the firmware 220 may process the read command having a higher priority before processing the write command or such that the write command may not interfere with the processing of the read command. The write command may have a higher priority than that of the reading command in the second feature (FEATURE 2) such that the firmware 220 may process the write command having a higher priority before processing the read command or such that the read command may not interfere with the processing of the write command.

The term of “preferentially process a command” may be referred to as “process a command having a higher priority,” “process a command without being interrupted by other commands,” “process a command by interrupting other command,” “process a command by delaying processing of other commands,” “delay other commands until a command is completed,” or “not generating other commands when a command is generated,” for example.

Further, when the second module 222 is a module associated with the operating frequency of the storage 200, the second module 222 may include a third feature (FEATURE A) to drive the storage 200 at a low frequency (e.g., low clock frequency), a fourth feature (FEATURE B) to drive the storage 200 at a high frequency (e.g., high clock frequency), and a fifth feature (FEATURE C) to drive the storage 200 at a configuration frequency received from the host 100.

Further, when the third module 223 is a module associated with the garbage collection of the storage 200, the third module 223 may include a sixth feature (FEATURE a) to allow the storage 200 to perform garbage collection, a seventh feature (FEATURE b) to stop the garbage collection of the storage 200, and an eighth feature (FEATURE c) to allow the storage 200 to perform garbage collection at a configuration frequency received from the host 100.

Whether or not to enable each feature is determined by the adaptation controller 210. The adaptation controller 210 may receive a configuration command from the configuration controller 110 of the host 100 and enable a feature corresponding to the configuration command.

When the corresponding feature is enabled according to the configuration command, operating characteristics of the storage 200 can be set or determined. Thus, the storage controller 230 sends/receives the contents 240 to/from the host 100 while driving the storage 200 according to the set characteristics.

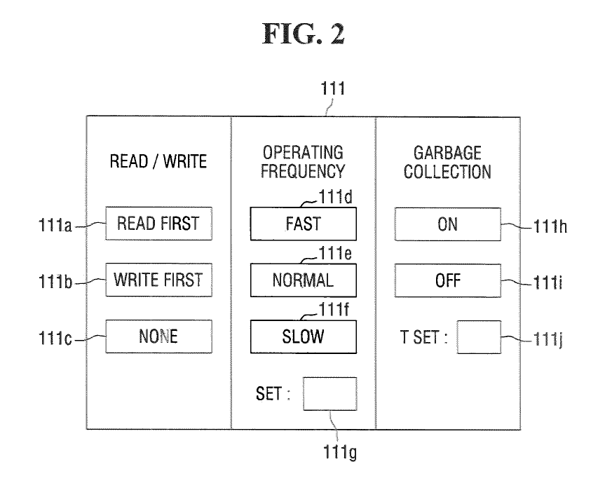

Hereinafter, an operation of a memory system according to an embodiment of the present general inventive concept will be described in detail with reference to FIGS. 2 to 7.

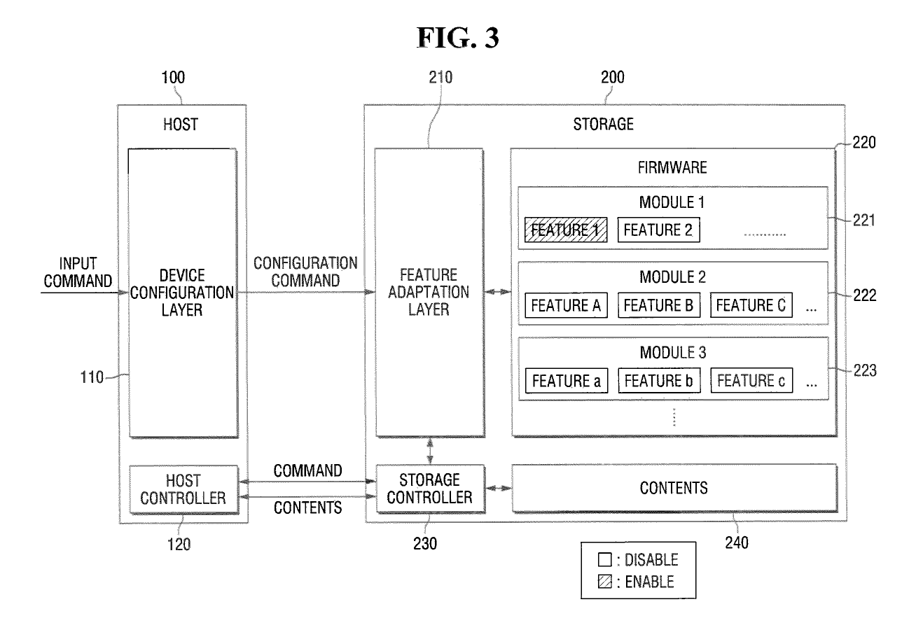

FIG. 2 illustrates a user interface 111 included in the configuration controller 110 of FIG. 1. FIGS. 3 to 7 are diagrams illustrating an operation of the memory system of FIG. 1 according to an embodiment of the present general inventive concept.

As described above, the configuration controller 110 of the host 100 may include the user interface 111 to receive the input command from the user. The user interface 111 of FIG. 2 is one example of the user interface of the configuration controller 110 of FIG. 1.

Referring to FIG. 2, the user interface 111 may include a first button 111a to generate a configuration command such that the storage 200 preferentially processes a read command over a write command, a second button 111b to generate a configuration command such that the storage 200 preferentially processes a write command over a read command, and a third button 111c to generate a configuration command such that the storage 200 processes read and write commands without setting a priority thereon.

There are one or more different categories in the contents 240. When the contents 240 stored in the storage 200 are one category, for example, e-books, the host 100 may send more read commands than write commands to the storage 200 during performing the operation on the e-books. Accordingly, in this use environment, the storage 200 is required to preferentially process a read command over a write command. In this case, the user may enable the first button 111a included in the user interface 111 to generate a configuration command such that the storage 200 preferentially processes a read command over a write command.

It is possible that the host 100 automatically controls the user interface 111 to select the first button 111a to generate a read command more than a write command such that a user does not have to manually enable the first button 111a when the category, that is the e-books, is selected by the user. This may be applied to other categories of the contents 240 or user environments hereinafter.

Although not illustrated, the host 100 may have another user interface such that the user can select one of the categories of the contents 240. According to the user selection through the another user interface, the host 100 may perform an operation associated with the selected category of the contents 240. This may also be applied to other categories of the contents 240 or user environments hereinafter.

Referring to FIG. 3, the generated configuration command is provided to the adaptation controller 210, and the adaptation controller 210 enables the first feature (FEATURE 1) of the first module 221 included in the firmware 220. In this case, the adaptation controller 210 may disable the second feature (FEATURE 2) for preferentially processing a write command over a read command.

When the contents 240 stored in the storage 200 are another category, for example, documents or word processing documents, the host 100 may send more write commands than read commands to the storage 200 during performing the operation on the documents. In this case, the user may enable the second button 111b, and the adaptation controller 210 may enable the second feature (FEATURE 2) and disable the first feature (FEATURE 1) of the first module 221 through a process similar to that as described above.

When the read operation and the write operation are expected to be balanced or equally performed in view of the characteristics of the contents 240 stored in the storage 200, the user may enable the third button 111c, and the adaptation controller 210 may enable or disable both the first feature (FEATURE 1) and the second feature (FEATURE 2) through a process similar to that as described above.

Referring back to FIG. 2, the user interface 111 may include a fourth button 111d to generate a configuration command such that the storage 200 is driven at a first frequency, a fifth button 111e to generate a configuration command such that the storage 200 is driven at a second frequency lower than the first frequency, and a sixth button 111f to generate a configuration command such that the storage 200 is driven at a third frequency lower than the second frequency. Further, the user interface 111 may additionally include a first input section 111g to allow the user to directly input a desired configuration frequency.

When a state of the storage 200, for example, a drive environment of the storage 200, is a high temperature environment, when the storage 200 is continuously driven at a high frequency, the performance of the storage 200 may deteriorate. Accordingly, in this case, the user may enable the sixth button 111f included in the user interface 111 to generate a configuration command such that the storage 200 is driven at different driving frequency, for example, at a relatively low driving frequency.

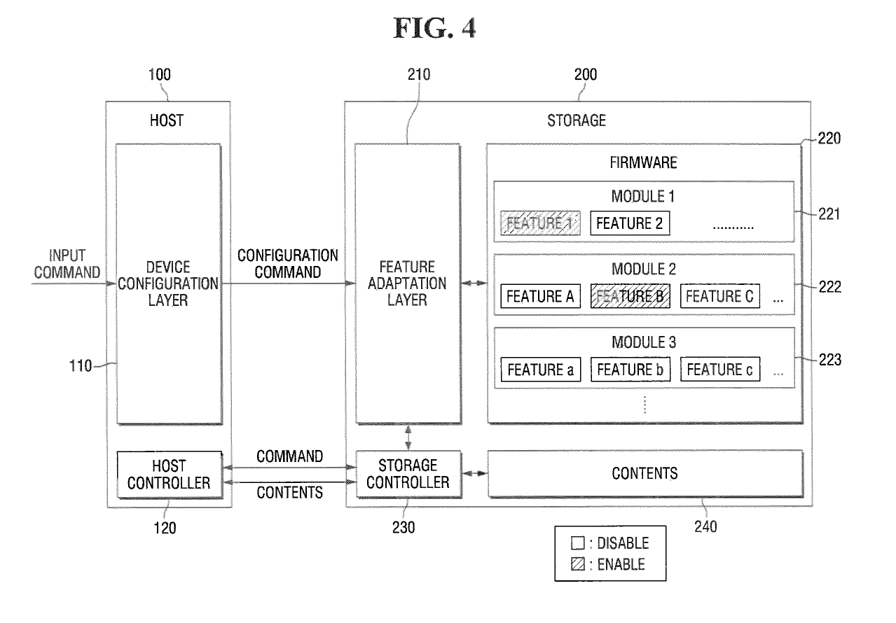

Referring to FIG. 4, the generated configuration command is provided to the adaptation controller 210, and the adaptation controller 210 may enable the fourth feature (FEATURE B), and disable the third feature (FEATURE A) of the second module 222 included in the firmware 220.

On the other hand, when the drive environment of the storage 200 is a low temperature environment, the storage 200 is required to be driven at a high frequency to generate heat to thereby maintain the performance of the storage 200. In this case, the user may enable the fourth button 111d included in the user interface 111, thereby disabling the fourth feature (FEATURE B) and enabling the third feature (FEATURE A). When there is no need to separately set the driving frequency of the storage 200, the user may enable the fifth button 111e included in the user interface 111, thereby disabling or enabling both the third feature (FEATURE A) and the fourth feature (FEATURE B).

Further, when the user intends to manually set the driving frequency of the storage 200, the user may input a configuration frequency to the first input section 111g included in the user interface 111 to thereby generate a configuration command such that the storage 200 is driven at the configuration frequency.

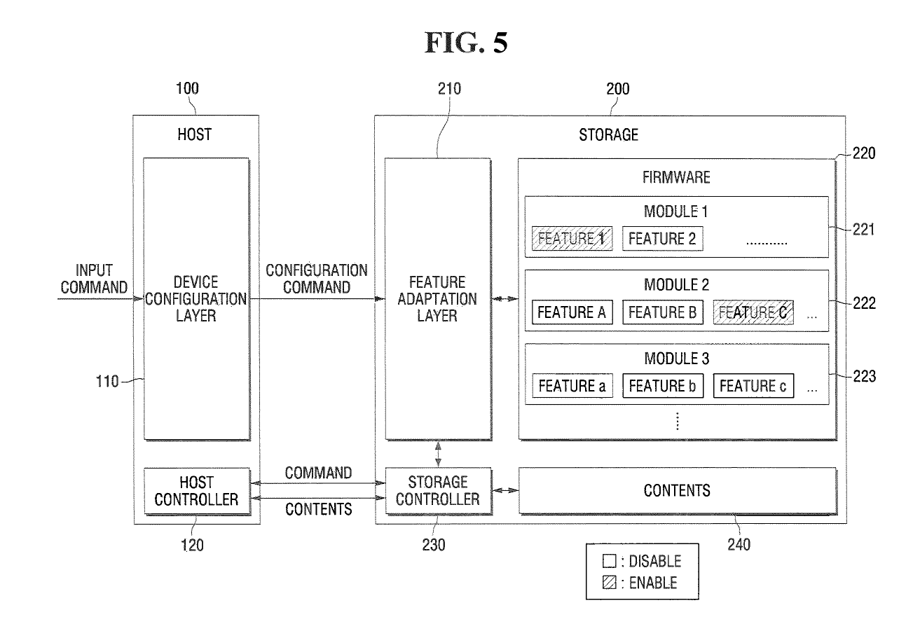

Referring to FIG. 5, the generated configuration command is provided to the adaptation controller 210, and the adaptation controller 210 may enable the fifth feature (FEATURE C) of the second module 222 included in the firmware 220. In this case, the storage 200 is driven at the configuration frequency received from the host 100.

Referring again back to FIG. 2, the user interface 111 may include a seventh button 111h to generate a configuration command such that the storage 200 performs a garbage collection, and an eighth button 111i to generate a configuration command such that the storage 200 does not perform the garbage collection. Further, the user interface 111 may additionally include a second input section 111j to allow the user to directly input a desired garbage collection cycle.

If the state of the storage 200 requires a garbage collection, the user may enable the seventh button 111h included in the user interface 111 to generate a configuration command such that the garbage collection is performed in the storage 200.

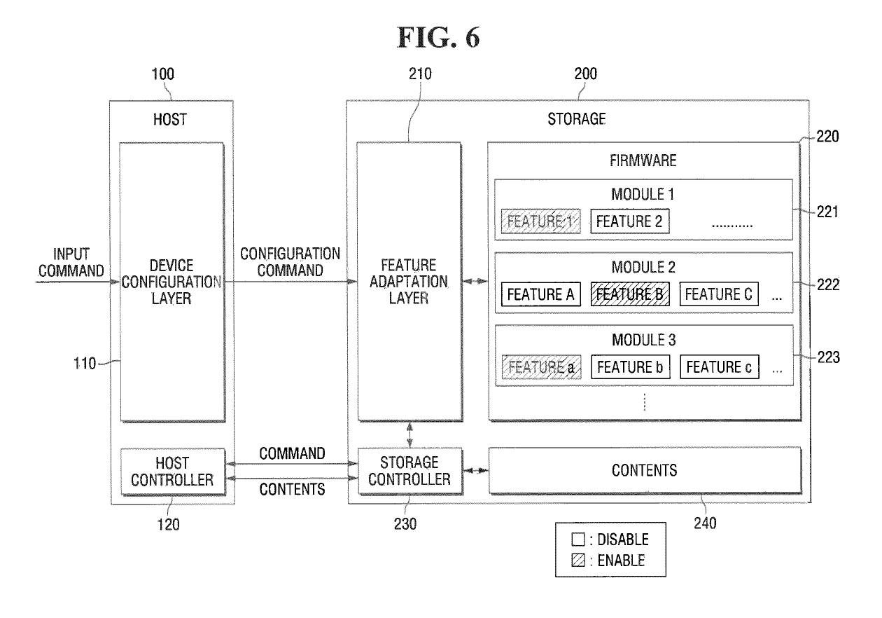

Referring to FIG. 6, the generated configuration command is provided to the adaptation controller 210, and the adaptation controller 210 may enable the sixth feature (FEATURE a) and disable the seventh feature (FEATURE b) of the third module 223 included in the firmware 220.

When the state of the storage 200 requires no garbage collection, the user may enable the eighth button 111i included in the user interface 111, thereby disabling the sixth feature (FEATURE a) and enabling the seventh feature (FEATURE b). It is possible that the host 100 or the storage 200 may automatically enable the eighth button 111i according to the state of the storage 200.

Further, when the user intends to manually set a garbage collection cycle of the storage 200, the user may input a configuration cycle to the second input section 111j included in the user interface 111 to thereby generate a configuration command such that the storage 200 performs a garbage collection according to the configuration cycle.

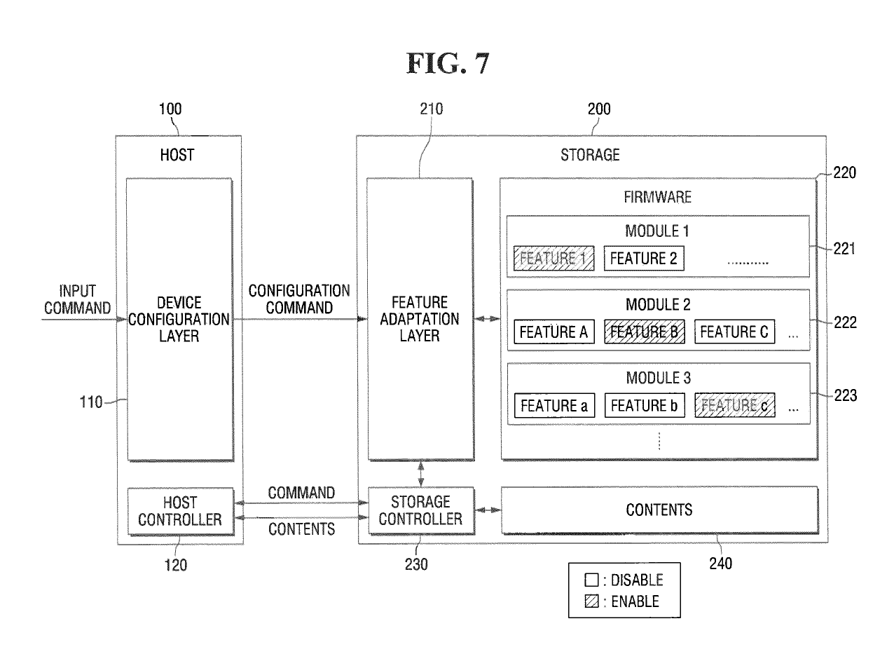

Referring to FIG. 7, the generated configuration command is provided to the adaptation controller 210, and the adaptation controller 210 may enable the eighth feature (FEATURE c) of the third module 223 included in the firmware 220. In this case, the storage 200 performs the garbage collection in the configuration cycle received from the host 100.

Although the operation of the memory system according to an embodiment of the present general inventive concept has been described using the exemplary functions of some features, the present general inventive concept is not limited thereto. The operation of the memory system according to embodiment of the present general inventive concept can be extended to other operations than the above-described examples. Further, although the user interface 111 that can be included in the configuration controller 110 has been illustrated as an example in FIG. 2, the user interface 111 can be also modified to provide information associated with the host 100 and/or the storage 200 to the user and/or to provide the command, data, or selection input by the user to the host 100 and/or the storage 200.

Meanwhile, although the input command has been inputted from the user through the user interface 111 in the above-described examples, it may be also modified such that the host 100 and the storage 200 can perform the operations thereof. For example, the host 100 or the storage 200 may further include a sensor (not illustrated) to sense a state of the storage 200 corresponding to one or more operational functions of the storage 200 such that the input command is generated from the sensor (not illustrated) and provided to the configuration controller 110 of the host 100.

Further, although the adaptation controller 210 and the storage controller 230 are illustrated as separate elements, the present general inventive concept is not limited thereto. That is, the adaptation controller 210 and the storage controller 230 may be implemented as one integrated unit if necessary.

In this embodiment, the storage 200 may be a semiconductor apparatus, for example, a solid state drive (SSD), in which a controller and a non-volatile memory device are integrated into one semiconductor device, but the present general inventive concept is not limited thereto.

Referring again to FIG. 1, the configuration controller 110 of the host 100 may provide the configuration command to the adaptation controller 210 of the storage 200 using a first interface. Further, the host controller 120 of the host 100 may send/receive the command and the contents to/from the storage controller 230 of the storage 200 using a second interface. The second interface may be generated from the storage controller 230 of the storage 200 and provided to the user such that the command and contents can be input to the storage controller 230 by the user through the second interface. The second interface may be provided through the host 100 such that the second interface can be provided to the user in the similar way to the first interface.

In an embodiment of the present general inventive concept, the first interface and the second interface may be different interfaces. For example, any one of the first interface and the second interface may have a short-range wireless communication mode, such as Bluetooth, near field communication (NFC), and radio frequency identification (RFID), and the other one of the first interface and the second interface may have a wired communication mode such as universal serial bus (USB), AT attachment (ATA), and serial ATA (SATA).

However, in an embodiment of the present general inventive concept, the first interface and the second interface may be the same interface. For example, the first interface and the second interface may be serial advanced technology attachment (SATA) interfaces. In this case, the configuration command may be provided from the configuration controller 110 to the adaptation controller 210 in the form of a SATA command through the SATA interface.

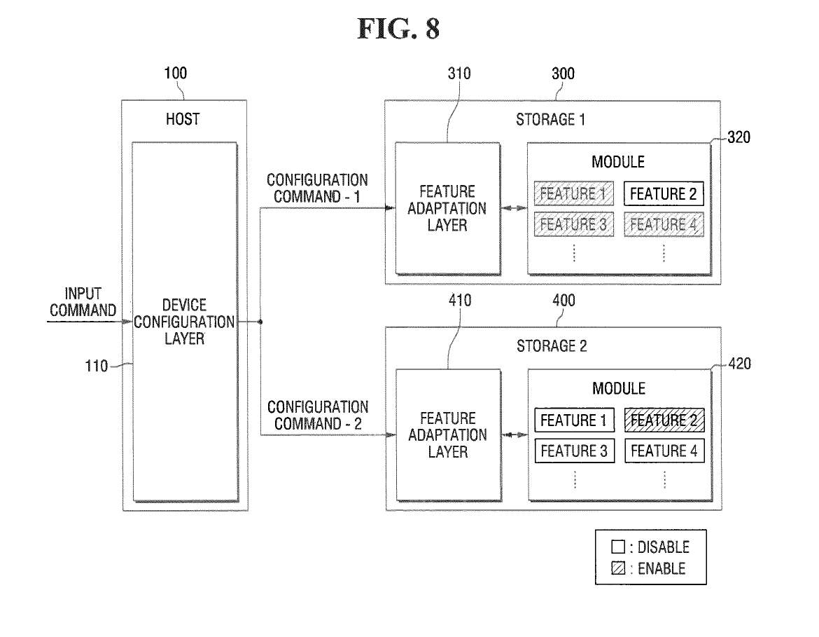

FIG. 8 is a block diagram illustrating a memory system according to an embodiment of the present general inventive concept.

Referring to FIG. 8, the memory system may include a host 100, a first storage 300 and a second storage 400. The host 100 may be configured in the same manner as the host 100 of FIG. 1. The first and second storages 300 and 400 may be also configured in the same manner as the storage 200 of FIG. 1. A portion of the configuration of FIG. 1 is omitted in FIG. 8 for convenience of explanation.

A configuration controller (device configuration layer) 110 of the host 100 may receive an input command and output a first configuration command (CONFIGURATION COMMAND-1) and a second configuration command (CONFIGURATION COMMAND-2) corresponding thereto. Here, the first configuration command (CONFIGURATION COMMAND-1) may be a command to determine whether to enable each of a plurality of features included in the first storage 300, and the second configuration command (CONFIGURATION COMMAND-2) may be a command to determine whether to enable each of a plurality of features included in the second storage 400.

A first adaptation controller (feature adaptation layer) 310 included in the first storage 300 may receive the first configuration command (CONFIGURATION COMMAND-1) from the configuration controller 110 and determine whether to enable each feature (FEATURE 1-4). Further, a second adaptation controller (feature adaptation layer) 410 included in the second storage 400 may receive the second configuration command (CONFIGURATION COMMAND-2) from the configuration controller 110 and determine whether to enable each feature (FEATURE 1-4).

Here, the first configuration command (CONFIGURATION COMMAND-1) and the second configuration command (CONFIGURATION COMMAND-2) may be different from each other according to the environments in which the first storage 300 and the second storage 400 are operated. Accordingly, as illustrated, the enabled feature (FEATURE 1, 3, 4) of the first storage 300 may be different from the enabled feature (FEATURE 2) of the second storage 400.

For example, when the contents stored in the first storage 300 are one type or category of contents, such as e-books, the first adaptation controller 310 may enable a first feature (FEATURE 1) and disable a second feature (FEATURE 2) included in a firmware module 320 according to the first configuration command (CONFIGURATION COMMAND-1). Thus, among the commands inputted to the first storage 300, a read command may be processed first.

Further, when the contents stored in the second storage 400 are another type or category of contents, such as word processing documents, the second adaptation controller 410 may enable a second feature (FEATURE 2) and disable a first feature (FEATURE 1) included in a firmware module 420 according to the second configuration command (CONFIGURATION COMMAND-2). Thus, among the commands inputted to the second storage 400, a write command may be processed first.

As described above, the enabled feature (FEATURE 1, 3, 4) of the first storage 300 and the enabled feature (FEATURE 2) of the second storage 400 may be modified in any way according to the environments in which the first storage 300 and the second storage 400 are operated.

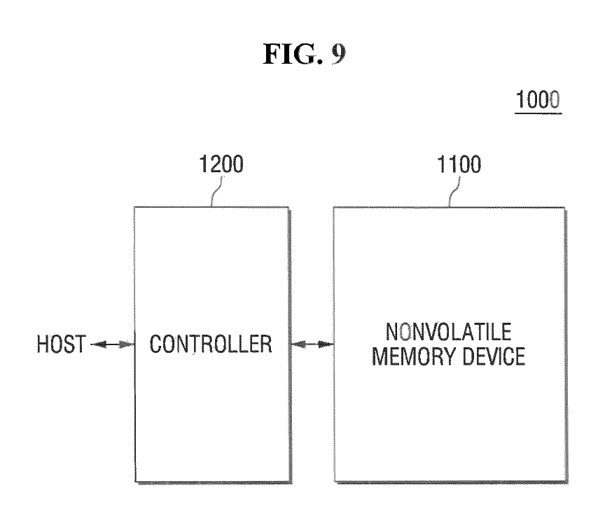

Hereinafter, a memory system according to an embodiment of the present general inventive concept and application examples thereof will be described with reference to FIGS. 9 to 11.

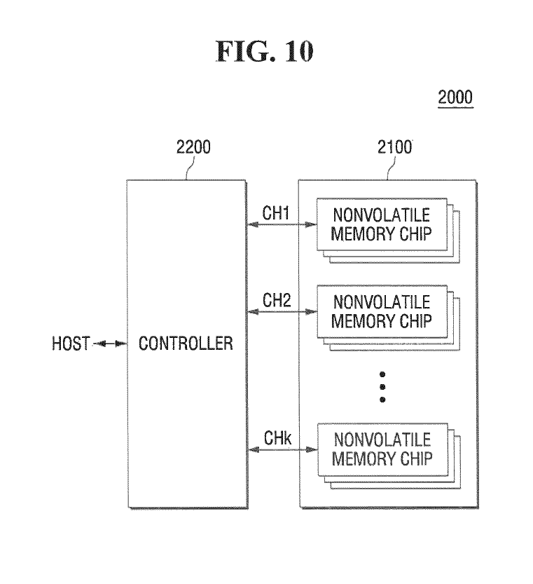

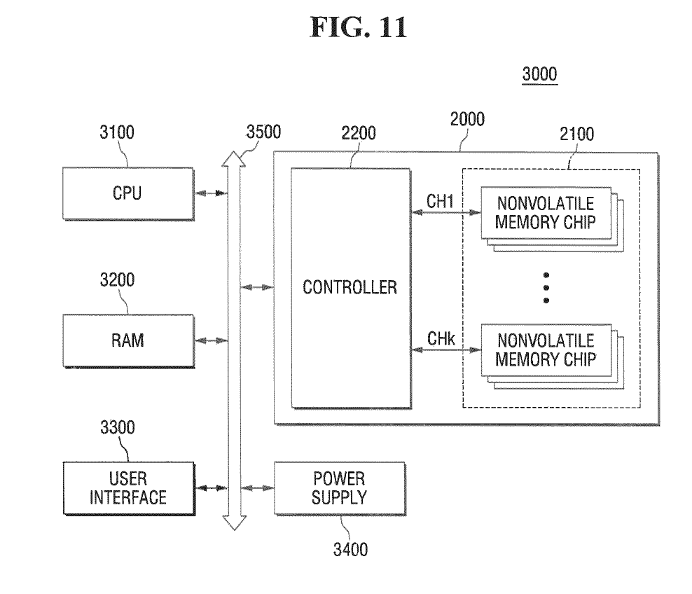

FIG. 9 is a block diagram illustrating a memory system 1000 according to an embodiment of the present general inventive concept. FIG. 10 is a block diagram illustrating a memory system 2000 as an application example of the memory system 1000 of FIG. 9. FIG. 11 is a block diagram illustrating a computing system 3000 including the memory system 2000 of FIG. 10.

Referring to FIG. 9, the memory system 1000 includes a non-volatile memory device 1100 and a controller 1200. Here, the controller 1200 and the non-volatile memory device 1100 may be integrated into a single body, for example, one semiconductor device, to constitute the above-mentioned solid state drive (SSD). The solid state drive (SSD) includes a storage device configured to store data in a semiconductor memory. In a case where the solid state drive (SSD) is used as the memory system 1000, an operation speed of a host connected to the memory system 1000 may be improved dramatically.

The controller 1200 is connected to a host and the non-volatile memory device 1100. In response to a request transmitted from the host, the controller 1200 is configured to access the non-volatile memory device 1100. For example, the controller 1200 is configured to control read, write, erase and background operations of the non-volatile memory device 1100. The controller 1200 is configured to provide an interface between the non-volatile memory device 1100 and the host. The controller 1200 is configured to operate a firmware to control the non-volatile memory device 1100.

The controller 1200 may further include well-known components such as a random access memory (RAM), a processing unit, a host interface, and a memory interface. The RAM is used as at least one of an operation memory of the processing unit, a cache memory between the non-volatile memory device 1100 and the host, and a buffer memory between the non-volatile memory device 1100 and the host. The processing unit controls all operations of the controller 1200.

The host interface includes a protocol to perform data exchange between the host and the controller 1200. For example, the controller 1200 is configured to perform communication with an external device (for example, host) through at least one of various interface protocols such as a universal serial bus (USB) protocol, a multimedia card (MMC) protocol, a peripheral component interconnection (PCI) protocol, a PCI-express (PCI-E) protocol, an advanced technology attachment (ATA) protocol, a serial-ATA protocol, a parallel-ATA protocol, a small computer small interface (SCSI) protocol, an enhanced small disk interface (ESDI) protocol, and an integrated drive electronics (IDE) protocol. The memory interface interfaces with the non-volatile memory device 1100. For example, the memory interface includes a NAND interface or NOR interface.

The memory system 1000 may be configured to additionally include an error correction block. The error correction block is configured to detect and correct an error of data read from the non-volatile memory device 1100 using an error correction code (ECC). As an example, the error correction block is provided as a component of the controller 1200. The error correction block may be provided as a component of the non-volatile memory device 1100.

As another example, the memory system 1000 is provided as one of various components of an electronic apparatus, such as a computer, ultra mobile PC (UMPC), workstation, net-book, personal digital assistants (PDA), portable computer, web tablet, wireless phone, mobile phone, smart phone, e-book, portable multimedia player (PMP), portable game console, navigation device, black box, digital camera, 3-dimensional television, digital audio recorder, digital audio player, digital picture recorder, digital picture player, digital video recorder, digital video player, apparatus capable of transmitting and receiving information in wireless environment, one of various electronic apparatuses constituting the home network, one of various electronic apparatuses constituting the computer network, one of various electronic apparatuses constituting the telematics network, radio-frequency identification (RFID) device, and one of various components forming the computing system.

Specifically, the non-volatile memory device 1100 or the memory system 1000 may be mounted as various types of packages. For example, the non-volatile memory device 1100 or the memory system 1000 may be mounted as a package such as package on package (PoP), ball grid arrays (BGAs), chip scale packages (CSPs), plastic leaded chip carrier (PLCC), plastic dual in line package (PDIP), die in waffle pack, die in wafer form, chip on board (COB), ceramic dual in line package (CERDIP), plastic metric quad flat pack (MQFP), thin quad flat pack (TQFP), small outline (SOIC), shrink small outline package (SSOP), thin small outline (TSOP), thin quad flat pack (TQFP), system in package (SIP), multi chip package (MCP), wafer-level fabricated package (WFP), wafer-level processed stack package (WSP).

Referring to FIG. 10, the memory system 2000 includes a non-volatile memory device 2100 and a controller 2200. The non-volatile memory device 2100 includes a plurality of non-volatile memory chips. The non-volatile memory chips are classified into a plurality of groups. Each group of the non-volatile memory chips is configured to perform communication with the controller 2200 via one common channel. For example, the non-volatile memory chips perform communication with the controller 2200 via a number of channels, for example, first to k-th channels CH1 to CHk.

Although FIG. 10 illustrates a plurality of non-volatile memory chips connected to one channel, it can be understood that the memory system 2000 may be modified such that one non-volatile memory chip is connected to one channel.

Referring to FIG. 11, the computing system 3000 includes a central processing unit 3100, a random access memory (RAM) 3200, a user interface 3300, a power supply 3400, and the memory system 2000.

The memory system 2000 is electrically connected to the central processing unit 3100, the RAM 3200, the user interface 3300 and the power supply 3400 via a system bus 3500. The data provided through the user interface 3300 or processed by the central processing unit 3100 is stored in the memory system 2000.

FIG. 11 illustrates a case where the non-volatile memory device 2100 is connected to the system bus 3500 through the controller 2200. However, the non-volatile memory device 2100 may be configured to be directly connected to the system bus 3500.

Although FIG. 11 illustrates the memory system 2000 described as the memory system 1000 of FIG. 10, the memory system 100 of FIG. 9 can be used as the memory system 2000 of FIG. 11.

For instance, the computing system 3000 may be configured to include both of the memory systems 1000 and 2000 described with reference to FIGS. 9 and 10.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A memory system comprising:
a host including a configuration controller to receive an input command and to output a configuration command corresponding to the input command; and
a storage to be driven by firmware including a plurality of features, the storage including an adaptation controller to receive the configuration command from the configuration controller and to determine whether to enable each of the features.

2. The memory system of claim 1, wherein:
the plurality of features include a first feature to drive the storage to preferentially process a read command among commands inputted to the storage, and a second feature to drive the storage to preferentially process a write command among commands inputted to the storage; and
the adaptation controller enables any one of the first and second features and disables the other one of the first and second features according to the received configuration command.

3. The memory system of claim 1, wherein:
the plurality of features include a first feature to drive the storage at a first frequency, and a second feature to drive the storage at a second frequency higher than the first frequency; and
the adaptation controller enables any one of the first and second features and disables the other one of the first and second features according to the received configuration command.

4. The memory system of claim 1, wherein:
the plurality of features include a first feature to drive the storage at a first frequency; and
the adaptation controller determines whether to enable the first feature according to the received configuration command.

5. The memory system of claim 4, wherein the first frequency is provided to the adaptation controller through the configuration command.

6. The memory system of claim 1, wherein:
the plurality of features include a first feature to perform garbage collection in the storage in a first cycle; and
the adaptation controller determines whether to enable the first feature according to the received configuration command.

7. The memory system of claim 6, wherein the first cycle is provided to the adaptation controller through the configuration command.

8. The memory system of claim 1, wherein:
the storage stores contents being processed by the host; and
an interface used when the storage provides the contents to the host is different from an interface used when the configuration controller provides the configuration command to the adaptation controller.

9. The memory system of claim 1, wherein:
the storage stores contents being consumed by the host; and
the storage includes an interface used when the storage provides the contents to the host, and the configuration controller includes an interface used when the configuration controller provides the configuration command to the adaptation controller.

10. The memory system of claim 9, wherein the interface includes a serial advanced technology attachment (SATA) interface.

11. The memory system of claim 10, wherein the configuration command is provided from the configuration controller to the adaptation controller in the form of a SATA command.

12. The memory system of claim 1, wherein the storage includes a solid state disk (SSD).

13. The memory system of claim 1, wherein the configuration controller includes a user interface (UI) configured to receive the input command from a user.

14. A memory system comprising:
a host including a configuration controller to receive an input command and to output first and second configuration commands corresponding to the input command; and
a first storage to be driven by a first firmware including a plurality of features, the first storage including a first adaptation controller to receive the first configuration command from the configuration controller and to determine whether to enable each of the features; and
a second storage to be driven by a second firmware including a plurality of features, the second storage including a second adaptation controller to receive the second configuration command from the configuration controller and to determine whether to enable each of the features,
wherein an enabled feature of the first storage is different from an enabled feature of the second storage.

15. The memory system of claim 14, wherein:
the plurality of features include a first feature to drive the storage to preferentially process a read command among commands inputted to the storage, and a second feature to drive the storage to preferentially process a write command among commands inputted to the storage;
the first feature of the first storage is enabled and the first feature of the second storage is disabled; and
the second feature of the first storage is disabled and the second feature of the second storage is enabled.

16. A storage usable with a memory system having a host, comprising:
a firmware including a plurality of features; and
an adaptation controller to receive a configuration command and to determine whether to enable each of the features according to the received configuration command.

17. The storage of clam 16, wherein the configuration command is associated with a characteristic of contents stored in the storage or to be stored in the storage.

18. The storage of claim 16, wherein the configuration command is associated with a state of the storage.

19. The storage of claim 16, wherein:
the firmware includes a plurality of modules;
one of the plurality of modules includes the plurality of features; and
the adaptation controller enables one of the plurality of features according to the configuration command.

20. The storage of claim 19, wherein:
the other one of the plurality of modules includes a plurality of second features; and
one of the second features is enabled according to a state of the storage during an operation of the storage.
